(19) United States
(12) Patent Application Publication
(10) Pub. No.: US 2023/0221629 A1
(43) Pub. Date: Jul. 13, 2023

(54) LIGHT GUIDING UNIT, MANUFACTURING METHOD FOR LIGHT GUIDING UNIT, LIGHT SOURCE, AND PROJECTOR

(71) Applicant: SEIKO EPSON CORPORATION, Tokyo (JP)

(72) Inventors: Hidefumi SAKATA, Azumino-Shi (JP); Yuichiro IWAMA, Azumino-Shi (JP)

(21) Appl. No.: 18/153,660

(22) Filed: Jan. 12, 2023

(30) Foreign Application Priority Data
Jan. 12, 2022 (JP) 2022-002990

(51) Int. Cl. G03B 21/20

(52) U.S. Cl. CPC G03B 21/204; G03B 21/2066

(57) ABSTRACT

A light guiding unit of the present disclosure includes a light guiding member, an angle conversion member, and an adhesive. The light guiding member has an output end surface crossing longitudinal directions of the light guiding member and a side surface crossing the output end surface. The angle conversion member has an incident end surface entered by the light output from the output end surface. In a sectional view orthogonal to the output end surface, a dimension of the incident end surface is larger than a dimension of the output end surface. A part of the adhesive is provided between the output end surface and the incident end surface and another part of the adhesive is provided to cover a part of the side surface. In the sectional view orthogonal to the output end surface, a dimension of the adhesive provided to cover the part of the side surface is equal to or larger than the dimension of the output end surface and equal to or smaller than the dimension of the incident end surface, and the dimension of the adhesive is gradually larger from the side surface toward the incident end surface.

The present application is based on, and claims priority from JP Application Serial Number 2022-002990, filed Jan. 12, 2022, the disclosure of which is hereby incorporated by reference herein in its entirety.

### BACKGROUND

### 1. Technical Field

The present disclosure relates to a light guiding unit, a manufacturing method for a light guiding unit, a light source, and a projector.

### 2. Related Art

As a light source used for a projector, a light source using fluorescence emitted from phosphor when the phosphor is irradiated with an excitation light output from a light emitting device is proposed.

JP-T-2020-526877 discloses a light source device including a solid-state light source outputting a blue light, a light-transmissive member in a rod shape containing phosphor that wavelength-converts the blue light, and a compound radiation surface condenser that collimates fluorescence output from the light-transmissive member. The compound radiation surface condenser is fixed to an end portion of the light-transmissive member using an adhesive.

In the light source device of JP-T-2020-526877, in some cases, the fluorescence generated within the phosphor is not sufficiently extracted from the compound radiation surface condenser. In the cases, it may be difficult to obtain the fluorescence having desired intensity. As above, the light source device with wavelength conversion is explained as an example and, also, in a light source device without wavelength conversion, provision of a light guiding unit having excellent extraction efficiency is desired.

### SUMMARY

In order to solve the above described problem, a light guiding unit according to an aspect of the present disclosure includes a light guiding member outputting a light, an angle conversion member converting an angle distribution of the light output from the light guiding member, and an adhesive provided between the light guiding member and the angle conversion member and having light transmissivity, wherein the light guiding member has an output end surface crossing longitudinal directions of the light guiding member and outputting the light and a side surface crossing the output end surface, the angle conversion member has an incident end surface entered by the light output from the output end surface, in a sectional view orthogonal to the output end surface, a dimension of the incident end surface is larger than a dimension of the output end surface, a part of the adhesive is provided between the output end surface and the incident end surface and another part of the adhesive is provided to cover a part of the side surface, in the sectional view orthogonal to the output end surface, a dimension of the adhesive provided to cover the part of the side surface is equal to or larger than the dimension of the output end surface and equal to or smaller than the dimension of the incident end surface, and the dimension of the adhesive is gradually larger from the side surface toward the incident end surface.

A manufacturing method for a light guiding unit according to an aspect of the present disclosure is a manufacturing method for a light guiding unit including a light guiding member outputting a light, an angle conversion member converting an angle distribution of the light output from the light guiding member, and an adhesive provided between the light guiding member and the angle conversion member and having light transmissivity, the light guiding member having an output end surface crossing longitudinal directions of the light guiding member and outputting the light and a side surface crossing the output end surface, the angle conversion member having an incident end surface entered by the light output from the output end surface, in a sectional view orthogonal to the output end surface, a dimension of the incident end surface being larger than a dimension of the output end surface, a part of the adhesive provided between the output end surface and the incident end surface and another part of the adhesive provided to cover a part of the side surface, including a first step of performing processing of adjusting a lyophilic property to the adhesive at least on one of a part of the incident end surface in contact with the adhesive and a part of the side surface, and a second step of providing the adhesive between the output end surface and the incident end surface and in a portion covering the part of the side surface and bonding the light guiding member and the angle conversion member performed after the first step.

A light source according to an aspect of the present disclosure includes the light guiding unit according to the aspect of the present disclosure and a light emitting device outputting a light to the light guiding unit.

A projector according to an aspect of the present disclosure includes the light source according the aspect of the present disclosure, a light modulation device modulating the light output from the light source according to image information, and a projection optical device projecting the light modulated by the light modulation device.

### BRIEF DESCRIPTION OF THE DRAWINGS

FIG. 1 is a schematic configuration diagram of a projector of a first embodiment.

FIG. 2 is a schematic configuration diagram of a first illumination device of the first embodiment.

FIG. 3 is an enlarged sectional view of a main part of a wavelength conversion unit of the first embodiment.

FIG. 4 is a schematic diagram showing a contact angle between an angle conversion member and an adhesive.

FIG. 5 is a schematic diagram showing a contact angle between a wavelength conversion member and the adhesive.

FIG. 6 is a side sectional view showing a first lyophilic property adjustment portion and a second lyophilic property adjustment portion.

FIG. 7 is a top sectional view showing the first lyophilic property adjustment portion and the second lyophilic property adjustment portion.

FIG. 8 is a sectional view showing a wavelength conversion unit of a first comparative example.

FIG. 9 is a sectional view showing a wavelength conversion unit of a second comparative example.

FIG. 10 is an enlarged sectional view of a main part of a wavelength conversion unit of a second embodiment.

FIG. 11 is an enlarged sectional view of a main part of a wavelength conversion unit of a third embodiment.

### DESCRIPTION OF EXEMPLARY EMBODIMENTS

### First Embodiment

As below, a first embodiment of the present disclosure will be explained using the drawings.

A projector of the embodiment is an example of a projector using a liquid crystal panel as a light modulation device.

In the following respective drawings, to secure the visibility of the respective component elements, scales of dimensions of some component elements may be made different.

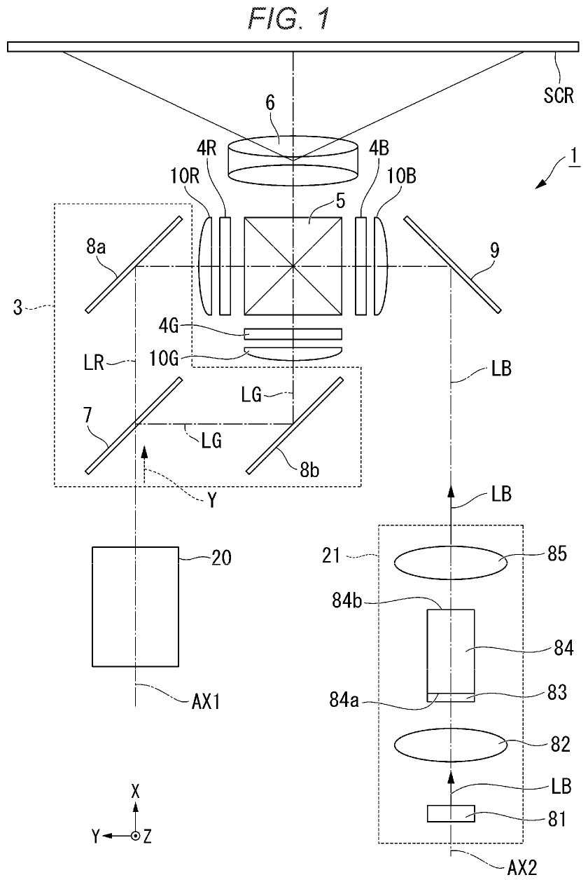

FIG. 1 shows a schematic configuration of a projector 1 of the embodiment.

As shown in FIG. 1, the projector 1 of the embodiment is a projection-type image display apparatus displaying a color image on a screen SCR. The projector 1 includes three light modulation devices corresponding to respective color lights of a red light LR, a green light LG, and a blue light LB.

The projector 1 includes a first illumination device 20, a second illumination device 21, a color separation system 3, a light modulation device 4R, a light modulation device 4G, a light modulation device 4B, a light combining element 5, and a projection optical device 6.

The first illumination device 20 outputs yellow fluorescence Y toward the color separation system 3. The second illumination device 21 outputs the blue light LB toward the light modulation device 4B. The detailed configurations of the first illumination device 20 and the second illumination device 21 will be described later.

As below, in the drawings, an XYZ orthogonal coordinate system is used for explanation as necessary. The Z-axis is an axis along upward and downward directions of the projector 1. The X-axis is an axis parallel to an optical axis AX1 of the first illumination device 20 and an optical axis AX2 of the second illumination device 21. The Y-axis is an axis orthogonal to the X-axis and the Z-axis. The optical axis AX1 of the first illumination device 20 is a center axis of the fluorescence Y output from the first illumination device 20. The optical axis AX2 of the second illumination device 21 is a center axis of the blue light LB output from the second illumination device 21.

The color separation system 3 separates the yellow fluorescence Y output from the first illumination device 20 into the red light LR and the green light LG. The color separation system 3 includes a dichroic mirror 7, a first reflection mirror 8a, and a second reflection mirror 8b.

The dichroic mirror 7 separates the fluorescence Y into the red light LR and the green light LG. The dichroic mirror 7 transmits the red light LR and reflects the green light LG. The second reflection mirror 8b is placed in an optical path of the green light LG. The second reflection mirror 8b reflects the green light LG reflected by the dichroic mirror 7 toward the light modulation device 4G. The first reflection mirror 8a is placed in an optical path of the red light LR. The first reflection mirror 8a reflects the red light LR transmitted through the dichroic mirror 7 toward the light modulation device 4R.

On the other hand, the blue light LB output from the second illumination device 21 is reflected by a reflection mirror 9 toward the light modulation device 4B.

As below, the configuration of the second illumination device 21 will be explained.

The second illumination device 21 includes a light source unit 81, a condenser lens 82, a diffuser plate 83, a rod lens 84, and a relay lens 85. The light source unit 81 includes at least one semiconductor laser. The light source unit 81 outputs the blue light LB of a laser beam. Note that the light source unit 81 is not limited to the semiconductor laser, but may include an LED emitting a blue light.

The condenser lens 82 includes a convex lens. The condenser lens 82 substantially focuses and enters the blue light LB output from the light source unit 81 into the diffuser plate 83. The diffuser plate 83 diffuses the blue light LB output from the condenser lens 82 with predetermined diffusivity, and generates the blue light LB having a substantially uniform intensity distribution like that of the fluorescence Y output from the first illumination device 20. As the diffuser plate 83, e.g. frosted glass of optical glass is used.

The blue light LB diffused by the diffuser plate 83 enters the rod lens 84. The rod lens 84 has a prism shape extending along the optical axis AX2 of the second illumination device 21. The rod lens 84 has a light-incident end face 84a provided on one end and a light-exiting face 84b provided on the other end. The diffuser plate 83 is fixed to the light-incident end face 84a of the rod lens 84 via an optical adhesive (not shown). It is desirable that the refractive index of the diffuser plate 83 and the refractive index of the rod lens 84 are set to be as equal as possible.

The blue light LB is totally reflected and propagates within the rod lens 84 and is output from the light-exiting face 84b with increased uniformity of the illuminance distribution. The blue light LB output from the rod lens 84 enters the relay lens 85. The relay lens 85 enters the blue light LB with the uniformity of the illuminance distribution increased by the rod lens 84 into the reflection mirror 9.

The shape of the light-exiting face 84b of the rod lens 84 is a rectangular shape substantially similar to the shape of the image formation area of the light modulation device 4B. Thereby, the blue light LB output from the rod lens 84 efficiently enters the image formation area of the light modulation device 4B.

The light modulation device 4R modulates the red light LR according to image information and forms an image light corresponding to the red light LR. The light modulation device 4G modulates the green light GR according to the image information and forms an image light corresponding to the green light LG. The light modulation device 4B modulates the blue light LB according to the image information and forms an image light corresponding to the blue light LB.

For the respective light modulation device 4R, light modulation device 4G, and light modulation device 4B, e.g. transmissive liquid crystal panels are used. Further, polarizers (not shown) are respectively placed at the light-incident sides and the light-exiting sides of the liquid crystal panels. The polarizer passes only linear-polarized light in a particular direction.

A field lens 10R is placed at the light-incident side of the light modulation device 4R. A field lens 10G is placed at the light-incident side of the light modulation device 4G. A field lens 10B is placed at the light-incident side of the light modulation device 4B. The field lens 10R parallelizes the principal ray of the red light LR entering the light modulation device 4R. The field lens 10G parallelizes the principal ray of the green light LG entering the light modulation device 4G. The field lens 10B parallelizes the principal ray of the blue light LB entering the light modulation device 4B.

The image lights output from the light modulation device 4R, the light modulation device 4G, and the light modulation device 4B enter the light combining element 5, and the element combines the image lights corresponding to the red light LR, the green light LG, and the blue light LB and outputs the combined image light toward the projection optical device 6. For the light combining element 5, e.g. a cross dichroic prism is used.

The projection optical device 6 includes a plurality of projection lenses. The projection optical device 6 enlarges and projects the image light combined by the light combining element 5 toward the screen SCR. Thereby, an image is displayed on the screen SCR.

As below, the configuration of the first illumination device 20 will be explained.

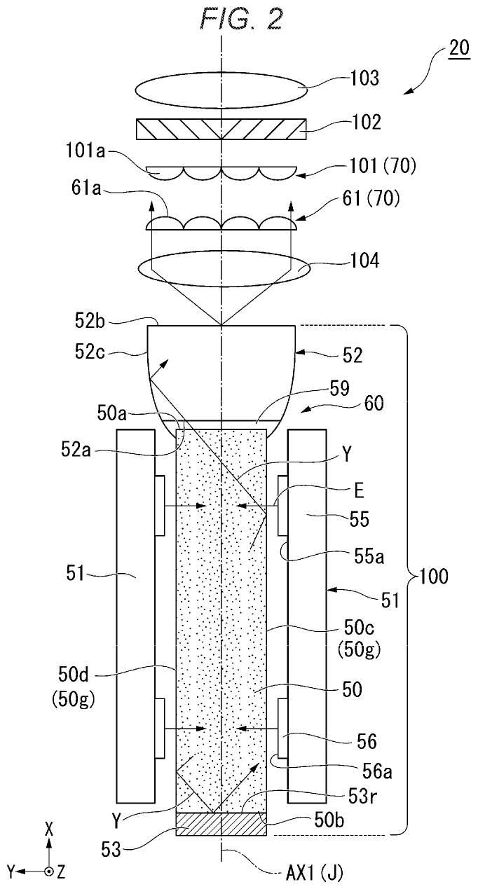

FIG. 2 is a schematic configuration diagram of the first illumination device 20.

As shown in FIG. 2, the first illumination device 20 includes a light source 100, an optical integration system 70, a polarization conversion element 102, a superimposition system 103, and a condenser lens 104.

The light source 100 includes a wavelength conversion unit 60 and a light source unit 51. The wavelength conversion unit 60 (light guiding unit) includes a wavelength conversion member 50, an angle conversion member 52, an adhesive 59, and a reflection member 53.

The wavelength conversion member 50 has a quadrangular prism shape extending in the X-axis directions and has six surfaces. A side extending in the X-axis directions of the wavelength conversion member 50 is longer than a side extending in the Y-axis directions and a side extending in the Z-axis directions. Therefore, the X-axis directions correspond to the longitudinal directions of the wavelength conversion member 50. The length of the side extending in the Y-axis directions and the length of the side extending in the Z-axis directions are equal. That is, the sectional shape of the wavelength conversion member 50 cut along a plane perpendicular to the X-axis directions is a square shape. Note that the sectional shape of the wavelength conversion member 50 cut along a plane perpendicular to the X-axis directions may be a rectangular shape.

The wavelength conversion member 50 has an output end surface 50a crossing the longitudinal directions (X-axis directions) of the wavelength conversion member 50 and outputting fluorescence Y, which will be described later, a reflection end surface 50b crossing the longitudinal directions (X-axis directions) of the wavelength conversion member 50 and located at the opposite side to the output end surface 50a, a first side surface 50c and a second side surface 50d crossing the output end surface 50a and the reflection end surface 50b and located at opposite sides to each other, and a third side surface and a fourth side surface (not shown) crossing the first side surface 50c and the second side surface 50d and located at opposite sides to each other. In the following description, the four surfaces of the first side surface 50c, the second side surface 50d, the third side surface, and the fourth side surface are collectively referred to as “side surface 50g”.

Note that the wavelength conversion member 50 does not necessarily have the quadrangular prism shape, but may have a triangular prism shape, a columnar shape, or the like. When the shape of the wavelength conversion member 50 is a triangular prism shape, three surfaces crossing the output end surface 50a and the reflection end surface 50b are collectively referred to as “side surface 50g”. When the shape of the wavelength conversion member 50 is a columnar shape, one continuous curved surface crossing the output end surface 50a and the reflection end surface 50b is referred to as “side surface 50g”.

The wavelength conversion member 50 contains at least phosphor and converts an excitation light E (first light) having a first wavelength range into fluorescence Y (second light) having a second wavelength range different from the first wavelength range. In the embodiment, the excitation light E enters the wavelength conversion member 50 from the respective first side surface 50c and second side surface 50d. The fluorescence Y is guided within the wavelength conversion member 50, and then, output from the output end surface 50a.

The wavelength conversion member 50 contains ceramic phosphor of polycrystalline phosphor that wavelength-converts the excitation light E into the fluorescence Y. The second wavelength range of the fluorescence Y is e.g. a yellow wavelength range from 490 to 750 nm. That is, the fluorescence Y is yellow fluorescence containing a red light component and a green light component.

The wavelength conversion member 50 may contain single-crystalline phosphor in place of the polycrystalline phosphor. Or, the wavelength conversion member 50 may be formed using fluorescent glass. Or, the wavelength conversion member 50 may be formed using a material containing many fluorescent particles dispersed in a binder of glass or resin. The wavelength conversion member 50 formed using the above described material converts the excitation light E into the fluorescence Y having the second wavelength range.

Specifically, the material of the wavelength conversion member 50 contains e.g. yttrium aluminum garnet (YAG) phosphor. YAG:Ce containing cerium (Ce) as an activator agent is taken as an example. As the material of the wavelength conversion member 50, a material formed by mixing and solid-phase reaction of raw material powder containing component elements of Y₂O₃, Al₂O₃, CeO₃, etc., Y−Al—O amorphous particles obtained by a wet process such as a coprecipitation process or a sol-gel process, YAG particles obtained by a gas-phase process such as a spray drying process, a flame decomposition method, a thermal plasma method, or the like are used.

The light source unit 51 includes a substrate 55 and light emitting devices 56. The light emitting device 56 has a light emission surface 56a outputting the excitation light E in the first wavelength range. The light source unit 51 is provided to face the respective first side surface 50c and second side surface 50d of the wavelength conversion member 50. The light emitting device 56 includes e.g. a light emitting diode (LED). As described above, the light source unit 51 is provided to face a part of the side surface 50g along the longitudinal directions of the wavelength conversion member 50. Note that the number and the placement of the light source units 51 are not particularly limited.

The light emission surfaces 56a of the light emitting devices 56 are placed to face the respective first side surface 50c and second side surface 50d of the wavelength conversion member 50 and output the excitation lights E to the respective first side surface 50c and second side surface 50d. The first wavelength range is e.g. a wavelength range from blue to violet from 400 nm to 480 nm and the peak wavelength is e.g. 445 nm.

The substrate 55 supports the light emitting devices 56. A plurality of the light emitting devices 56 are provided on one surface 55a of the substrate 55. In the case of the embodiment, the light source unit 51 includes the light emitting devices 56 and the substrate 55, and may include other optical members such as a light guide plate, a diffuser plate, and a lens. The number of the light emitting devices 56 provided on the substrate 55 is not particularly limited.

The reflection member 53 is provided to face the reflection end surface 50b of the wavelength conversion member 50. The reflection member 53 guides the light within the wavelength conversion member 50 and reflects the fluorescence Y reaching the reflection end surface 50b. The reflection member 53 is a member separately provided from the wavelength conversion member 50 and formed using a plate-like member of a metal material e.g. aluminum. The reflection member 53 has a reflection surface 53r facing the reflection end surface 50b of the wavelength conversion member 50 and reflecting the fluorescence Y. The reflection surface 53r may be a surface of the metal material itself or a metal film or a dielectric multilayer film formed on the surface of the metal material.

In the light source 100, when the excitation lights E output from the light emitting devices 56 enter the wavelength conversion member 50, the phosphor contained in the wavelength conversion member 50 is excited and the fluorescence Y is emitted from an arbitrary light emission point. The fluorescence Y travels in all directions from the arbitrary light emission point, and the fluorescence Y traveling toward the side surface 50g travels toward the output end surface 50a or the reflection end surface 50b while repeating total reflection in a plurality of portions of the side surface 50g. The fluorescence Y traveling toward the output end surface 50a enters the angle conversion member 52 via the adhesive 59, which will be described later. On the other hand, the fluorescence Y traveling toward the reflection end surface 50b is reflected by the reflection member 53 and travels toward the output end surface 50a.

Of the excitation lights E entering the wavelength conversion member 50, a part of the excitation lights E not used for the excitation of the phosphor is reflected by the members around the wavelength conversion member 50 including the light emitting devices 56 of the light source unit 51 or the reflection member 53 provided on the reflection end surface 50b. Accordingly, the part of the excitation lights E is confined within the wavelength conversion member 50 and reused.

The angle conversion member 52 is provided at the light-exiting side of the output end surface 50a of the wavelength conversion member 50 via the adhesive 59. The angle conversion member 52 includes a compound parabolic concentrator (CPC). The angle conversion member 52 is formed using a light-transmissive material e.g. borosilicate glass such as N-BK7 or cycloolefin resin such as E-48R.

The angle conversion member 52 has an incident end surface 52a entered by the fluorescence Y output from the output end surface 50a of the wavelength conversion member 50, a light-exiting surface 52b outputting the fluorescence Y, and four reflection surfaces 52c reflecting the fluorescence Y toward the light-exiting surface 52b.

The cross-sectional area of the angle conversion member 52 perpendicular to an optical axis J is gradually larger from the incident end surface 52a to the light-exiting surface 52b. Therefore, the area of the light-exiting surface 52b is larger than the area of the incident end surface 52a. Further, the area of the cross section (YZ-plane) connecting the respective reflection surfaces 52c, and perpendicular to the X-axis is gradually larger from the incident end surface 52a to the light-exiting surface 52b. When the angle conversion member 52 is seen from a direction perpendicular to the optical axis J (Z-axis direction), the shapes of the respective reflection surfaces are parabolic shapes. Here, an axis passing through the centers of the light-exiting surface 52b and the incident end surface 52a and parallel to the X-axis is the optical axis J of the angle conversion member 52. The optical axis J of the angle conversion member 52 is aligned with the optical axis AX1 of the first illumination device 20.

The fluorescence Y entering the angle conversion member 52 changes the direction thereof so as to be closer to the direction parallel to the optical axis J at each time when being totally reflected by the reflection surfaces 52c while traveling within the angle conversion member 52. In this manner, the angle conversion member 52 converts the output angle distribution of the fluorescence Y output from the output end surface 50a of the wavelength conversion member 50. Specifically, the angle conversion member 52 sets the maximum output angle of the fluorescence Y on the light-exiting surface 52b to be smaller than the maximum incident angle of the fluorescence Y on the incident end surface 52a.

Generally, etendue of a light defined by a product of the area of the light-exiting area and the solid angle of the light (maximum output angle) is conserved, and etendue of the fluorescence Y is conserved before and after the transmission of the angle conversion member 52. As described above, the angle conversion member 52 has the configuration in which the area of the light-exiting surface 52b is larger than the area of the incident end surface 52a. Accordingly, in view of etendue conservation, the angle conversion member 52 may set the maximum output angle of the fluorescence Y on the light-exiting surface 52b to be smaller than the maximum incident angle of the fluorescence Y entering the incident end surface 52a.

The angle conversion member 52 is fixed to the wavelength conversion member 50 with the incident end surface 52a facing the output end surface 50a of the wavelength conversion member 50 via the adhesive 59. That is, the adhesive 59 is provided between the angle conversion member 52 and the wavelength conversion member 50 and bonds the angle conversion member 52 and the wavelength conversion member 50. Therefore, no air gap (air layer) is provided between the angle conversion member 52 and the wavelength conversion member 50. The adhesive 59 has light transmissivity. For the adhesive 59, e.g. a silicone resin adhesive having a thermosetting or ultraviolet curable property (Model Number: SCR1016, manufactured by Shin-Etsu Chemical Co., Ltd.) is used.

If an air gap is provided between the angle conversion member 52 and the wavelength conversion member 50, of the fluorescence Y reaching the incident end surface 52a of the angle conversion member 52, the fluorescence Y entering the incident end surface 52a at an angle equal to or larger than the critical angle is totally reflected by the incident end surface 52a and does not enter the angle conversion member 52. On the other hand, according to the embodiment, when no air gap is provided between the angle conversion member 52 and the wavelength conversion member 50, the fluorescence Y not entering the angle conversion member 52 may be reduced. In the viewpoint, it is desirable that the refractive index of the angle conversion member 52 and the refractive index of the wavelength conversion member 50 are as equal as possible. Note that, actually, the wavelength conversion member 50 is formed using a material containing phosphor of YAG or the like and the angle conversion member 52 is formed using the light transmissive material of borosilicate glass or the like, and it is hard to set the refractive indexes to be equal. Accordingly, it is desirable that at least the refractive index of the angle conversion member 52 and the refractive index of the adhesive 59 are as equal as possible.

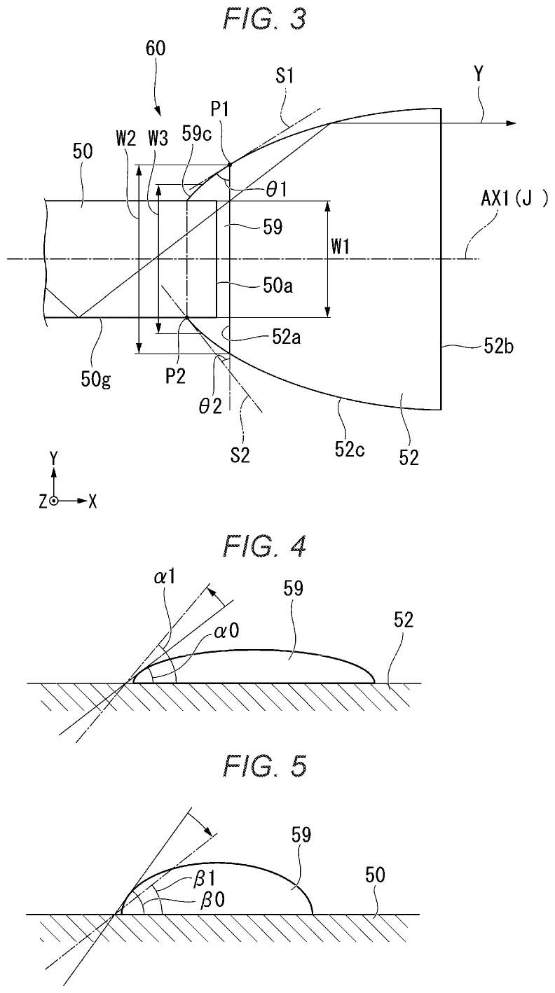

FIG. 3 is an enlarged sectional view of a main part of the wavelength conversion unit 60. In FIG. 3, a dimension W1 of the output end surface 50a is defined by a distance of a virtual line connecting one end in the Y-axis direction to the other end in the Y-axis direction in the output end surface 50a. Further, a dimension W2 of the incident end surface 52a is defined by a distance of a virtual line connecting one end in the Y-axis direction to the other end in the Y-axis direction in the incident end surface 52a. Furthermore, a dimension W3 of the adhesive 59 is defined by a distance of a virtual line connecting one end in the Y-axis direction to the other end in the Y-axis direction in the adhesive 59. The virtual lines are straight lines overlapping with the optical axis J of the angle conversion member 52 and parallel to the Y-axis directions orthogonal thereto. In FIG. 3, the case where the respective dimensions W1 to W3 are compared in the Y-axis directions is taken as an example, however, the respective dimensions may be compared in the X-axis directions.

As shown in FIG. 3, in the sectional view (XY-plane) orthogonal to the output end surface 50a, the dimension W2 of the incident end surface 52a of the angle conversion member 52 is larger than the dimension W1 of the output end surface 50a of the wavelength conversion member 50. A part of the adhesive 59 is provided between the output end surface 50a and the incident end surface 52a, and another part of the adhesive 59 is provided to cover a part of the side surface 50g of the wavelength conversion member 50. In the sectional view (XY-plane) orthogonal to the output end surface 50a, the dimension W3 of the adhesive 59 is equal to or larger than the dimension W1 of the output end surface 50a and equal to or smaller than the dimension W2 of the incident end surface 52a, and gradually larger from the side surface 50g of the wavelength conversion member 50 toward the incident end surface 52a of the angle conversion member 52.

The outer surface of the adhesive 59 is a curved surface and smoothly continuous to the reflection surfaces 52c of the angle conversion member 52. That is, an outer surface 59c of the adhesive 59 has a substantially parabolic shape like the reflection surfaces 52c of the angle conversion member 52. Therefore, the reflection surfaces 52c of the angle conversion member 52 and the outer surface 59c of the adhesive 59 form one substantially continuous parabolic surface as a whole. In the sectional view (XY-plane) orthogonal to the output end surface 50a, a contact point between the outer surface 59c of the adhesive 59 and the incident end surface 52a of the angle conversion member 52 is referred to as “contact point P1”. A contact point between the outer surface 59c of the adhesive 59 and the side surface 50g of the wavelength conversion member 50 is referred to as “contact point P2”. Here, an angle θ1 formed by a tangential line S1 of the outer surface 59c of the adhesive 59 passing through the contact point P1 and the incident end surface 52a is larger than an angle θ2 formed by a tangential line S2 of the outer surface 59c of the adhesive 59 passing through the contact point P2 and the incident end surface 52a. Hereinafter, the angles θ1, θ2 formed by the tangential lines S1, S2 of the outer surface 59c of the adhesive 59 and the incident end surface 52a are referred to as “inclination angles θ1, θ2” of the outer surface 59c of the adhesive 59.

Note that the contact point P2 refers to a point at which the outer surface 59c of the adhesive 59 continuous from the reflection surfaces 52c of the angle conversion member 52 substantially contacts the side surface 50g of the wavelength conversion member 50. In the embodiment, even when the adhesive 59 wetly spreads flatly and thinly on the side surface 50g of the wavelength conversion member 50 due to e.g. unintended inflow of the adhesive 59, the end portion of the wet spread adhesive 59 does not refer to the above described contact point P2.

In the embodiment, for example, when the reflection surfaces 52c of the angle conversion member 52 are parabolic surfaces having particular shapes, the inclination angle θ1 of the outer surface 59c of the adhesive 59 at the contact point P1 is 58.8°. The inclination angle θ2 of the outer surface 59c of the adhesive 59 at the contact point P2 is 55.8°. As described above, the inclination angle θ1 of the outer surface 59c of the adhesive 59 at the contact point P1 is larger than the inclination angle θ2 of the outer surface 59c of the adhesive 59 at the contact point P2. In other words, the inclination angle of the outer surface 59c of the adhesive 59 is gradually larger from the side surface 50g of the wavelength conversion member 50 toward the incident end surface 52a of the angle conversion member 52.

As shown in FIG. 2, the condenser lens 104 is provided to face the light-exiting surface 52b of the angle conversion member 52. The condenser lens 104 parallelizes the fluorescence Y output from the angle conversion member 52. That is, the degree of parallelization of the fluorescence Y having the angle distribution converted by the angle conversion member 52 is further increased by the condenser lens 104. The condenser lens 104 includes a convex lens. Note that, when the sufficient degree of parallelization is obtained only by the angle conversion member 52, the condenser lens 104 may be omitted as necessary.

The optical integration system 70 includes a first lens array 61 and a second lens array 101. The optical integration system 70 configures a uniform illumination system uniformizing the intensity distributions of the fluorescence Y output from the light source 100 in the respective light modulation devices 4R, 4G as illuminated areas with the superimposition system 103. The fluorescence Y output from the light-exiting surface 52b of the angle conversion member 52 enters the first lens array 61. The first lens array 61 forms the optical integration system 70 with the second lens array 101 provided at the downstream of the light source 100.

The first lens array 61 has a plurality of first small lenses 61a. The plurality of first small lenses 61a are arranged in a matrix form within the surface parallel to the YZ-plane orthogonal to the optical axis AX1 of the first illumination device 20. The plurality of first small lenses 61a divide the fluorescence Y output from the angle conversion member 52 into a plurality of partial luminous fluxes. The shapes of the respective first small lenses 61a are rectangular shapes substantially similar to the shapes of the image formation areas of the light modulation devices 4R, 4G. Thereby, the respective partial luminous fluxes output from the first lenses array 61 efficiently enter the image formation areas of the light modulation devices 4R, 4G.

The fluorescence Y output from the first lens array 61 travels toward the second lens array 101. The second lens array 101 is placed to face the first lens array 61. The second lens array 101 has a plurality of second small lenses 101a corresponding to the plurality of first small lenses 61a of the first lens array 61. The second lens array 101 forms respective images of the plurality of first small lenses 61a of the first lens array 61 near the image formation areas of the light modulation devices 4R, 4G with the superimposition system 103. The plurality of second small lenses 101a are arranged in a matrix form within the surface parallel to the YZ-plane orthogonal to the optical axis AX1 of the first illumination device 20.

In the embodiment, the respective first small lenses 61a of the first lens array 61 and the respective second small lenses 101a of the second lens array 101 have the same size as each other, however, may have different sizes from each other. Further, in the embodiment, the first small lenses 61a of the first lens array 61 and the second small lenses 101a of the second lens array 101 are arranged in positions in which the optical axes are aligned with each other, however, may be arranged eccentrically to each other.

The polarization conversion element 102 converts the polarization direction of the fluorescence Y output from the second lens array 101. Specifically, the polarization conversion element 102 converts the respective partial luminous fluxes of the fluorescence Y divided by the first lens array 61 and output from the second lens array 101 into linearly polarized lights.

The polarization conversion element 102 has a polarization separation layer (not shown) transmitting one linearly polarized light component of the polarization components contained in the fluorescence Y output from the light source 100 without change and reflecting the other linearly polarized light component in a direction perpendicular to the optical axis AX1, a reflection layer (not shown) reflecting the other linearly polarized light component reflected by the polarization separation layer in a direction parallel to the optical axis AX1, and a retardation film (not shown) converting the other linearly polarized light component reflected by the reflection layer into the one linearly polarized light component.

When the wavelength conversion unit 60 having the above described configuration is manufactured, as one means for forming the shape of the outer surface 59c of the adhesive 59 in the parabolic shape, in the embodiment, a lyophilic property of the adhesive 59 and the wavelength conversion member 50 and a lyophilic property of the adhesive 59 and the angle conversion member 52 are respectively adjusted. The lyophilic properties of the liquid adhesive 59 and the wavelength conversion member 50, and the angle conversion member 52 are adjusted and the contact angles between the liquid adhesive 59 and the wavelength conversion member 50 and the angle conversion member 52 are appropriately adjusted, the adhesive 59 is hardened, and thereby, the shape of the outer surface 59c of the adhesive 59 may be controlled to be the parabolic shape.

That is, a manufacturing method for the wavelength conversion unit 60 of the embodiment includes a first step of performing processing of adjusting a lyophilic property to the adhesive 59 at least on one of a part of the incident end surface 52a of the angle conversion member 52 and a part of the side surface 50g of the wavelength conversion member 50, which are in contact with the adhesive 59 and a second step of providing the adhesive 59 between the output end surface 50a and the incident end surface 52a and in the portion covering the part of the side surface 50g and bonding the wavelength conversion member 50 and the angle conversion member 52.

For the adjustment of the lyophilic property, the inventor dropped the liquid adhesive 59 to the respective wavelength conversion member 50 and angle conversion member 52 and measured contact angles of the adhesive 59. For the adhesive 59, silicone resin adhesive (SCR1016) was used. For the angle conversion member 52, borosilicate glass (N-BK7) was used. For the wavelength conversion member 50, YAG:Ce was used. Further, the measurements were performed using the angle conversion member 52 and the wavelength conversion member 50 not subjected to surface treatment.

FIG. 4 is a schematic diagram showing the contact angle between the angle conversion member 52 and the adhesive 59. FIG. 5 is a schematic diagram showing the contact angle between the wavelength conversion member 50 and the adhesive 59.

As shown in FIG. 4, when a predetermined amount of the adhesive 59 was dropped on the angle conversion member 52, a contact angle α0 of the adhesive 59 with the angle conversion member 52 was 20°. As shown in FIG. 5, when a predetermined amount of the adhesive 59 was dropped on the wavelength conversion member 50, a contact angle β0 of the adhesive 59 with the wavelength conversion member 50 was 49°. Note that, for the measurements of the contact angles, photographs were taken from sides of the wavelength conversion member 50 and the angle conversion member 52 with the adhesive 59 dropped thereon and inclination angles of the surfaces of the adhesive 59 were measured using a protractor. The time after the adhesive 59 is dropped and before the photographs are taken was set to one minute and the atmosphere temperature when the photographs are taken was set to 25° C.

In consideration of the inclination angles θ1, θ2 of the outer surface 59c of the adhesive 59 shown in FIG. 3 corresponding to the contact angles, the inclination angle θ1=58.8° of the adhesive 59 at the contact point P1 is the angle formed by the incident end surface 52a of the angle conversion member 52 and the tangential line S1 of the outer surface 59c of the adhesive 59 and equal to the contact angle, and therefore, a contact angle α1=58.8° may be set for forming the shape of the adhesive 59 as the parabolic surface. On the other hand, the inclination angle θ2=55.8° of the adhesive 59 at the contact point P2 is the angle formed by the incident end surface 52a and the tangential line S2 of the outer surface 59c of the adhesive 59. The side surface 50g of the wavelength conversion member 50 and the incident end surface 52a are orthogonal, and, and therefore, a contact angle pi may be expressed by β1=90°−θ2 and the contact angle β1=34.2° may be set for forming the shape of the adhesive 59 as the parabolic surface.

It is understood that, as described above, when the angle conversion member 52 and the wavelength conversion member 50 are not subjected to surface treatment, the respective contact angles α0, β0 obtained from the above described measurements largely separate from the contact angles α1, β1 for forming the shape of the adhesive 59 as the parabolic surface. Accordingly, for forming the shape of the adhesive 59 as the parabolic surface, as the first step, surface treatment to adjust lyophilic properties of the wavelength conversion member 50 and the angle conversion member 52 to the adhesive 59 may be performed to increase the contact angle from e.g. 20° to 58.8° with respect to the angle conversion member 52 and decrease the contact angle from e.g. 49° to 34.2° with respect to the wavelength conversion member 50. Note that the structure for adjusting the lyophilic properties is not shown in FIG. 3, however, as below, the structure for adjusting the lyophilic properties will be explained with reference to the drawings.

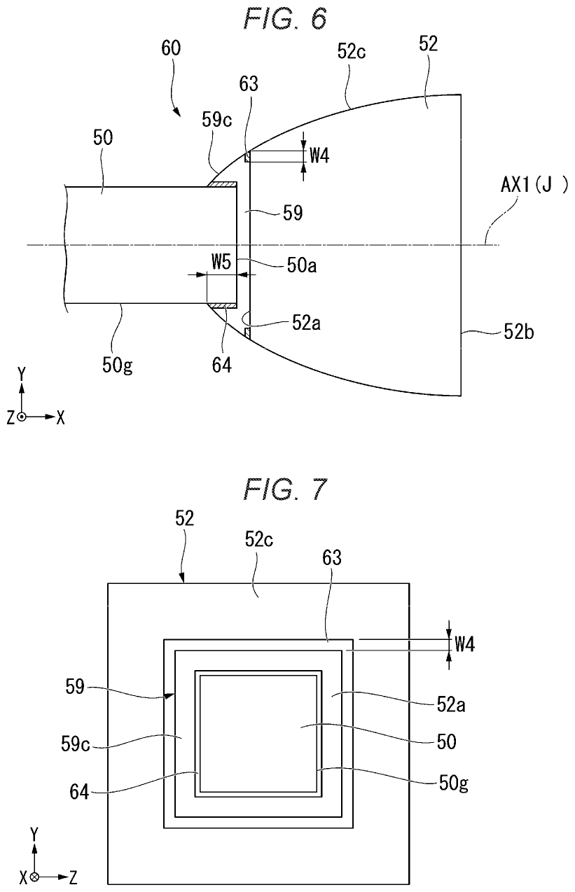

FIG. 6 is a side sectional view showing a main part of the wavelength conversion unit 60 including a configuration for forming the shape of the adhesive 59 as the parabolic surface. FIG. 7 is a top sectional view showing the main part of the wavelength conversion unit 60 including the configuration for forming the shape of the adhesive 59 as the parabolic surface.

In a case of the embodiment, as shown in FIGS. 6 and 7, a first lyophilic property adjustment portion 63 is provided in the peripheral part of the incident end surface 52a of the angle conversion member 52 in contact with the adhesive 59. The first lyophilic property adjustment portion 63 has a lyophilic property different from the lyophilic property in the center part of the incident end surface 52a and lower than the lyophilic property in the center part of the incident end surface 52a. A width W4 of the first lyophilic property adjustment portion 63 is about e.g. 1 mm or less.

A second lyophilic property adjustment portion 64 is provided in a part of the side surface 50g of the wavelength conversion member 50 in contact with the adhesive 59. The second lyophilic property adjustment portion 64 has a lyophilic property different from the lyophilic property of the side surface 50g not in contact with the adhesive 59 and higher than the lyophilic property of the side surface 50g not in contact with the adhesive 59. A width W5 of the second lyophilic property adjustment portion 64 is not particularly limited.

Specifically, the first lyophilic property adjustment portion 63 has a configuration formed by application of a fluorinated coating agent to the peripheral part of the incident end surface 52a of the angle conversion member 52. That is, the first lyophilic property adjustment portion 63 is formed by liquid-repellent treatment using the fluorinated coating agent on the peripheral part of the incident end surface 52a of the angle conversion member 52. Further, the second lyophilic property adjustment portion 64 has a configuration formed by application of a surface-active agent such as silicone oil, ethanol, or water to the side surface 50g of the wavelength conversion member 50. That is, the second lyophilic property adjustment portion 64 is formed by lyophilic treatment using the surface-active agent or the like on the side surface 50g of the wavelength conversion member 50. Note that the types of the materials of the coating agent used for the first lyophilic property adjustment portion 63 and the surface-active agent or the like used for the second lyophilic property adjustment portion 64 are changed, and thereby, the contact angles of the adhesive 59 with the wavelength conversion member 50 and the angle conversion member 52 may be adjusted.

In the above described manner, at the first step, the first lyophilic property adjustment portion 63 is formed in the peripheral part of the incident end surface 52a of the angle conversion member 52 and the second lyophilic property adjustment portion 64 is formed in a part of the side surface 50g of the wavelength conversion member 50. Then, as the second step, a predetermined amount of adhesive 59 is applied between the angle conversion member 52 and the wavelength conversion member 50, and then, heat or an ultraviolet ray is applied to the adhesive 59 and the adhesive is hardened. In this case, the shape of the hardened adhesive 59 is nearly unchanged from that before hardening. Further, the adhesive 59 is hardened with the contact angles restricted to desired values on both the incident end surface 52a of the angle conversion member 52 and the side surface 50g of the wavelength conversion member 50. Thereby, the outer surface 59c of the hardened adhesive 59 has a shape substantially conforming to a parabolic surface.

Note that, in the embodiment, the contact angles of the adhesive 59 are adjusted by application of the liquid-repellent material or the lyophilic material on the surfaces of the wavelength conversion member 50 and the angle conversion member 52, however, otherwise, the contact angles of the adhesive 59 may be adjusted by adjustment of e.g. a hardening condition including the temperature of the adhesive 59 at hardening. Further, when the contact angle of the adhesive 59 is decreased, a technique of air plasma treatment, oxygen plasma treatment, or the like may be used.

Furthermore, the temperature conditions when the adhesive 59 is dropped are changed, and thereby, the contact angles of the adhesive 59 with the wavelength conversion member 50 and the angle conversion member 52 may be adjusted. This method uses changes of the contact angles of the adhesive 59 by changes of surface free energy depending on the temperatures of the foundation on which the adhesive 59 is dropped. For example, the adhesive 59 is dropped with the wavelength conversion member 50 set at a higher temperature, thereby, the contact angle of the adhesive 59 with the wavelength conversion member 50 may be made smaller, and the adhesive 59 is dropped with the angle conversion member 52 at a lower temperature, thereby, the contact angle of the adhesive 59 with the angle conversion member 52 may be made larger.

In addition, in place of the method of forming the shape of the adhesive 59 as the parabolic surface by adjustment of the contact angles of the adhesive 59, a larger amount of adhesive 59 for the shape of the adhesive 59 protruding from a parabolic surface is applied between the angle conversion member 52 and the wavelength conversion member 50 and hardened, and then, the excessive adhesive 59 is polished for forming the shape of the adhesive 59 as the parabolic surface.

### COMPARATIVE EXAMPLES

As below, light sources of comparative examples will be explained.

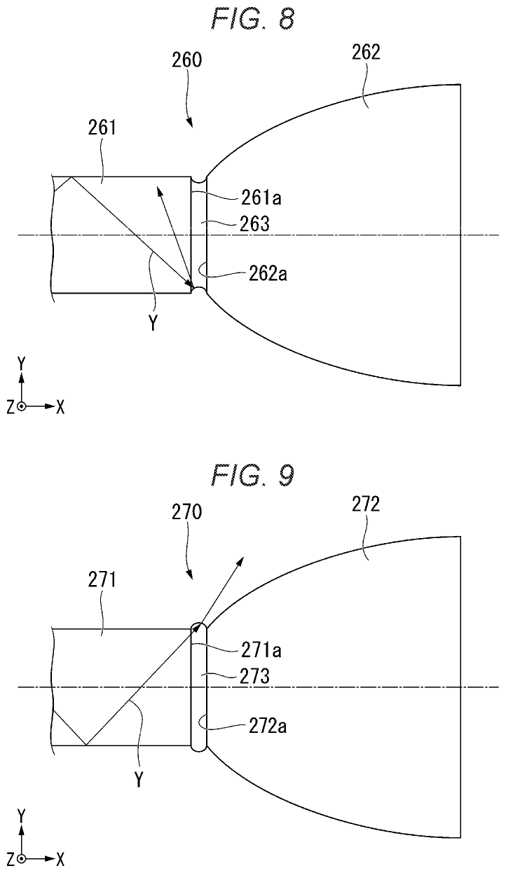

FIG. 8 is a sectional view showing a wavelength conversion unit 260 of a first comparative example.

As shown in FIG. 8, the wavelength conversion unit 260 of the first comparative example includes a wavelength conversion member 261, an angle conversion member 262, and an adhesive 263. The adhesive 263 is provided between an output end surface 261a of the wavelength conversion member 261 and an incident end surface 262a of the angle conversion member 262. The shape of the adhesive 263 is constricted due to a smaller amount of the adhesive 263 than the predetermined amount, contraction of the adhesive 263 at hardening, or the like. In directions parallel to the output end surface 261a (Y-axis directions), the dimension of the center part of the adhesive 263 is smaller than the dimensions of the output end surface 261a and the incident end surface 262a.

In this case, the optical path of the fluorescence Y from the wavelength conversion member 261 toward the angle conversion member 262 is narrowed in the portion of the adhesive 263 and the propagation of the fluorescence Y is hindered, and the amount of fluorescence Y entering the angle conversion member 262 is smaller compared to a case without the constricted shape of the adhesive 263. As a result, in the wavelength conversion unit 260 of the first comparative example, extraction efficiency of the fluorescence Y is lower and obtainment of the fluorescence Y having desired intensity may be harder.

FIG. 9 is a sectional view showing a wavelength conversion unit 270 of a second comparative example.

As shown in FIG. 9, the wavelength conversion unit 270 of the second comparative example includes a wavelength conversion member 271, an angle conversion member 272, and an adhesive 273. The adhesive 273 is provided between an output end surface 271a of the wavelength conversion member 271 and an incident end surface 272a of the angle conversion member 272. The shape of the adhesive 273 protrudes due to a larger amount of the adhesive 273 than the predetermined amount or the like. In directions parallel to the output end surface 271a (Y-axis directions), the dimension of the center part of the adhesive 273 is larger than the dimensions of the output end surface 271a and the incident end surface 272a.

In this case, part of the fluorescence Y from the wavelength conversion member 271 toward the angle conversion member 272 leaks out in the portion of the adhesive 273. As a result, in the wavelength conversion unit 270 of the second comparative example, extraction efficiency of the fluorescence Y is lower and obtainment of the fluorescence Y having desirable intensity may be harder. Further, part of the fluorescence Y even not leaking out is reflected by the outer surface of the adhesive 273 and the angle largely changes, and thereby, the angle distribution of the fluorescence Y output from the angle conversion member 272 largely spreads. As a result, the etendue of the fluorescence Y becomes larger and the amount of fluorescence Y not available in the optical system at the downstream of the wavelength conversion unit 270 may increase and light use efficiency may be lower.

### Effects of First Embodiment

The wavelength conversion unit 60 of the embodiment includes the wavelength conversion member 50 outputting the fluorescence Y, the angle conversion member 52 converting the angle distribution of the fluorescence Y output from the wavelength conversion member 50, and the adhesive 59 provided between the wavelength conversion member 50 and the angle conversion member 52 and having light transmissivity. The wavelength conversion member 50 has the output end surface 50a crossing the longitudinal directions of the wavelength conversion member 50 and outputting the fluorescence Y and the side surface 50g crossing the output end surface 50a. The angle conversion member 52 has the incident end surface 52a entered by the fluorescence Y output from the output end surface 50a. In the sectional view orthogonal to the output end surface 50a, the dimension of the incident end surface 52a is larger than the dimension of the output end surface 50a. A part of the adhesive 59 is provided between the output end surface 50a and the incident end surface 52a and another part of the adhesive 59 is provided to cover a part of the side surface 50g. In the sectional view orthogonal to the output end surface 50a, the dimension W3 of the adhesive 59 is equal to or larger than the dimension W1 of the output end surface 50a and equal to or smaller than the dimension W2 of the incident end surface 52a, and gradually larger from the side surface 50g toward the incident end surface 52a.

According to the configuration, the adhesive 59 is provided not only between the output end surface 50a and the incident end surface 52a but also to cover the part of the side surface 50g of the wavelength conversion member 50, has the dimension equal to or larger than the dimension W1 of the output end surface 50a and equal to or smaller than the dimension W2 of the incident end surface 52a, and is gradually larger from the side surface 50g toward the incident end surface 52a, and the adhesive 59 has no constricted part like that in the first comparative example or the protruding part like that in the second comparative example. Accordingly, the propagation of the fluorescence Y is not hindered in the portion of the adhesive 59 and leakage of the fluorescence Y outside is suppressed. Thereby, according to the embodiment, the wavelength conversion unit 60 in which the extraction efficiency of the fluorescence Y is higher and the fluorescence Y having desired intensity is obtained more easily than those of the wavelength conversion units of the first comparative example and the second comparative example may be realized.

In the wavelength conversion unit 60 of the embodiment, the angle conversion member 52 includes a CPC. According to the configuration, the angle distribution of the fluorescence Y output from the wavelength conversion unit 60 may be precisely controlled.

In the wavelength conversion unit 60 of the embodiment, the outer surface 59c of the adhesive 59 is the curved surface and, in the sectional view orthogonal to the output end surface 50a, the inclination angle θ1 of the outer surface 59c at the contact point P1 between the outer surface 59c and the incident end surface 52a is larger than the inclination angle θ2 of the outer surface 59c at the contact point P2 between the outer surface 59c and the side surface 50g.

According to the configuration, the shape of the outer surface 59c of the adhesive 59 may be made closer to a parabolic surface, and the outer surface 59c of the adhesive 59 and the reflection surfaces 52c of the angle conversion member 52 form one substantially continuous parabolic surface. Therefore, the adhesive 59 may function as a part of the angle conversion member 52. Thereby, a loss of the fluorescence Y due to a shift of the shape of the adhesive 59 from a parabolic surface may be sufficiently suppressed and the extraction efficiency of the fluorescence Y may be further increased.

Note that, in the embodiment, when the reflection surfaces 52c of the angle conversion member 52 is a parabolic surface having a particular shape, the inclination angle θ1 of the outer surface 59c of the adhesive 59 at the contact point P1 is set to 58.8° and the inclination angle θ2 of the outer surface 59c of the adhesive 59 at the contact point P2 is set to 55.8°, however, these values are just target values and, in the wavelength conversion unit 60 as a completed product, the inclination angles of the outer surface 59c of the adhesive 59 are not necessarily equal to the values. For example, the inclination angle θ1 does not necessarily reach 58.8°, but may be at least larger than 20° when the incident end surface 52a of the angle conversion member 52 is untreated. Further, the inclination angle θ2 does not necessarily reach 55.8°, but may be at least larger than 41° (=90°−49° corresponding to that when the side surface 50g of the wavelength conversion member 50 is untreated. When the inclination angles of the outer surface 59c of the adhesive 59 are not equal to the above described values, but when the condition that the inclination angle θ1 of the outer surface 59c passing through the contact point P1 is larger than the inclination angle θ2 of the outer surface 59c passing through the contact point P2 is satisfied, the shape of the outer surface 59c of the adhesive 59 may be made at least closer to the parabolic surface and the effects of the embodiment may be obtained.

In the wavelength conversion unit 60 of the embodiment, the first lyophilic property adjustment portion 63 having the lyophilic property different from the lyophilic property in the center part of the incident end surface 52a is provided in the peripheral part of the incident end surface 52a in contact with the adhesive 59.

According to the configuration, in the manufacturing process of the wavelength conversion unit 60, the contact angle of the adhesive 59 with the angle conversion member 52 may be adjusted, and the shape of the outer surface of the adhesive 59 in the portion in contact with the angle conversion member 52 may be easily controlled.

In the wavelength conversion unit 60 of the embodiment, the second lyophilic property adjustment portion 64 having the lyophilic property different from the lyophilic property of the side surface 50g not in contact with the adhesive 59 is provided in a part of the side surface 50g in contact with the adhesive 59.

According to the configuration, in the manufacturing process of the wavelength conversion unit 60, the contact angle of the adhesive 59 with the wavelength conversion member 50 may be adjusted, and the shape of the outer surface of the adhesive 59 in the portion in contact with the wavelength conversion member 50 may be easily controlled.

The manufacturing method for the wavelength conversion unit 60 of the embodiment is the manufacturing method for the wavelength conversion unit 60 including the wavelength conversion member 50 outputting the fluorescence Y, the angle conversion member 52 converting the angle distribution of the fluorescence Y output from the wavelength conversion member 50, and the adhesive 59 provided between the wavelength conversion member 50 and the angle conversion member 52 and having light transmissivity, the wavelength conversion member 50 having the output end surface 50a crossing the longitudinal directions of the wavelength conversion member 50 and outputting the fluorescence Y and the side surface 50g crossing the output end surface 50a, the angle conversion member 52 having the incident end surface 52a entered by the fluorescence Y output from the output end surface 50a, in the sectional view orthogonal to the output end surface 50a, the dimension of the incident end surface 52a being larger than the dimension of the output end surface 50a, a part of the adhesive 59 provided between the output end surface 50a and the incident end surface 52a and another part of the adhesive 59 provided to cover a part of the side surface 50g, including the first step of performing processing of adjusting the lyophilic property to the adhesive 59 on at least one of a part of the incident end surface 52a in contact with the adhesive 59 and a part of the side surface 50g and the second step of providing the adhesive 59 between the output end surface 50a and the incident end surface 52a and in the portion covering a part of the side surface 50g and bonding the wavelength conversion member 50 and the angle conversion member 52 performed after the first step.

According to the configuration, the adhesive 59 with the outer surface having the controlled shape may be rationally formed using surface tension of the adhesive 59. It is unnecessary to perform a polishing step of the adhesive 59 for the precisely controlled shape, and the manufacturing process of the wavelength conversion unit 60 may be simplified.

The light source 100 of the embodiment includes the wavelength conversion unit 60 and the light emitting devices 56 outputting exciting lights E to the wavelength conversion unit 60.

According to the embodiment, the light source 100 with excellent extraction efficiency of the fluorescence Y may be provided.

The projector 1 of the embodiment includes the light source 100 of the embodiment and has excellent light use efficiency.

### Second Embodiment

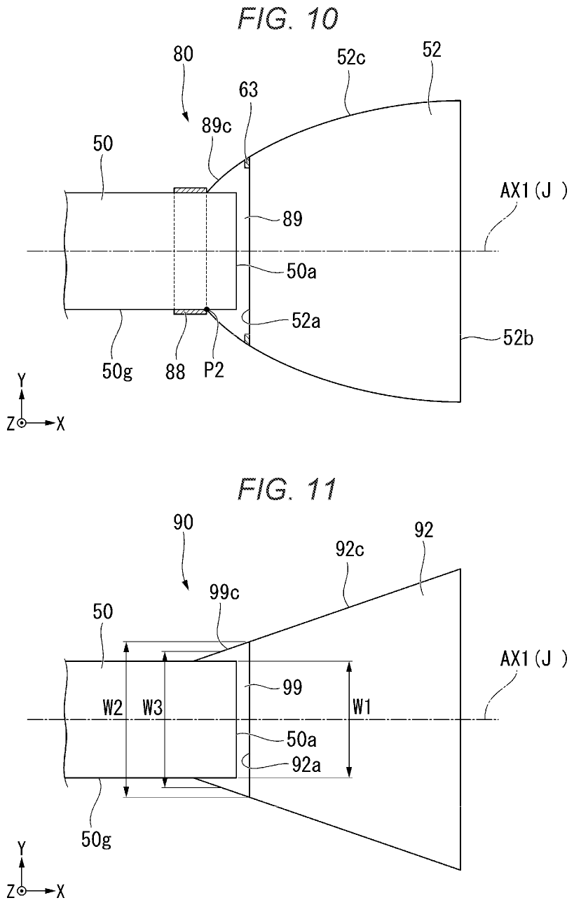

As below, a second embodiment of the present disclosure will be explained using FIG. 10.

The basic configurations of a projector and a light source of the second embodiment are the same as those of the first embodiment and the description of the basic configurations of the projector and the light source will be omitted.

FIG. 10 is an enlarged sectional view of a main part of a wavelength conversion unit 80 of the second embodiment.

In FIG. 10, the component elements in common with those in the drawings used in the first embodiment have the same signs and the description thereof is omitted.

As shown in FIG. 10, the wavelength conversion unit 80 of the embodiment includes the wavelength conversion member 50, the angle conversion member 52, and an adhesive 89. The first lyophilic property adjustment portion 63 is provided in the peripheral part of the incident end surface 52a of the angle conversion member 52 in contact with the adhesive 89. Further, a second lyophilic property adjustment portion 88 is provided in a part of the side surface 50g of the wavelength conversion member 50 not in contact with the adhesive 89, i.e., a part of the side surface 50g at the opposite side to the side at which the adhesive 89 is provided with respect to the contact point P2. The second lyophilic property adjustment portion 88 has a lyophilic property different from the lyophilic property of the side surface 50g in contact with the adhesive 89 and lower than the lyophilic property of the side surface 50g in contact with the adhesive 89. The second lyophilic property adjustment portion 88 has e.g. a configuration formed by application of a fluorinated coating agent to the side surface 50g of the wavelength conversion member 50. The other configurations of the wavelength conversion unit 80 are the same as those of the first embodiment.

### Effects of Second Embodiment

Also, in the embodiment, the same effects as those of the first embodiment that the wavelength conversion unit 80 in which the extraction efficiency of the fluorescence Y is higher and the fluorescence Y having desired intensity is easily obtained may be realized is obtained.

In the first embodiment, the example in which the contact angle of the adhesive 59 when the side surface 50g of the wavelength conversion member 50 is untreated (e.g. 49°) is larger than the predetermined contact angle for forming the shape of the adhesive 59 as the parabolic surface (e.g. 34.2°) is taken. On the other hand, depending on the type of the adhesive, contrary to the above described example, the contact angle of the adhesive 59 when the side surface 50g of the wavelength conversion member 50 is untreated may be smaller than the predetermined contact angle for forming the shape of the adhesive 59 as the parabolic surface. In this case, the second lyophilic property adjustment portion 88 having the lower lyophilic property is provided in a part of the side surface 50g of the wavelength conversion member 50, and thereby, wet spread of the adhesive 89 may be hindered and the contact angle may be increased. As described above, the configuration of the embodiment is preferable for the case using the adhesive 89 having the above described property.

### Third Embodiment

As below, a third embodiment of the present disclosure will be explained using FIG. 11.

The basic configurations of a projector and a light source of the third embodiment are the same as those of the first embodiment and the description of the basic configurations of the projector and the light source will be omitted.

FIG. 11 is an enlarged sectional view of a main part of a wavelength conversion unit 90 of the third embodiment.

In FIG. 11, the component elements in common with those in the drawings used in the first embodiment have the same signs and the description thereof is omitted.

As shown in FIG. 11, the wavelength conversion unit 90 of the embodiment includes the wavelength conversion member 50, an angle conversion member 92, and an adhesive 99. In the first embodiment and the second embodiment, the example using the CPC as the angle conversion member 52 is shown. On the other hand, in the embodiment, a taper rod is used as the angle conversion member 92. When the taper rod is used as the angle conversion member 92, respective four reflection surfaces 92c of the angle conversion member 92 are flat surfaces unlike the CPC.

In the sectional view (XY-plane) orthogonal to the output end surface 50a, the dimension W2 of an incident end surface 92a of the angle conversion member 92 is larger than the dimension W1 of the output end surface 50a of the wavelength conversion member 50. A part of the adhesive 99 is provided between the output end surface 50a and the incident end surface 92a and another part of the adhesive 99 is provided to cover a part of the side surface 50g of the wavelength conversion member 50. In the sectional view (XY-plane) orthogonal to the output end surface 50a, the dimension W3 of the adhesive 99 is equal to or larger than the dimension W1 of the output end surface 50a and equal to or smaller than the dimension W2 of the incident end surface 92a, and gradually larger from the side surface 50g of the wavelength conversion member 50 toward the incident end surface 92a of the angle conversion member 92.

An outer surface 99c of the adhesive 99 is a flat surface and smoothly continuous to the reflection surfaces 92c of the angle conversion member 92. Therefore, the reflection surfaces 92c of the angle conversion member 92 and the outer surface 99c of the adhesive 99 form one continuous flat surface as a whole. The other configurations of the wavelength conversion unit 90 are the same as those of the first embodiment.

### Effects of Third Embodiment

Also, in the embodiment, the same effects as those of the first embodiment that the wavelength conversion unit 90 in which the extraction efficiency of the fluorescence Y is higher and the fluorescence Y having desired intensity is easily obtained may be realized is obtained.

Note that the technical scope of the present disclosure is not limited to the above described embodiments and various changes can be made without departing from the scope of the present disclosure. Further, one aspect of the present disclosure may have a configuration formed by an appropriate combination of characteristic parts of the above described respective embodiments.

In the above described embodiments, the explanation is made on the assumption that the amount of the adhesive used for the manufacture of the wavelength conversion unit falls within a proper range. However, if the amount of the adhesive is larger beyond the proper range, the adhesive may overflow from the incident end surface of the angle conversion member and reach the reflection surface. In this case, when the contact angle of the adhesive on the reflection surface of the angle conversion member is larger, the outer shape of the angle conversion member may shift from a parabolic surface and the function of the angle conversion member becomes lower. As measures to the problem, lyophilic treatment to decrease the contact angle of the adhesive is performed on the reflection surface of the angle conversion member, and thereby, the adhesive thinly and wetly spreads along the reflection surface, the shape of the adhesive is closer to the original shape of the reflection surface, and the function decline of the angle conversion member may be suppressed. As described above, different surface treatment from that for the incident end surface may be performed on the reflection surface of the angle conversion member.

In the above described embodiments, the example in which the present disclosure is applied to the wavelength conversion unit is taken, however, in place of the configuration, the present disclosure may be applied to a light guiding unit propagating incident light without wavelength conversion, then, controlling the angle distribution, and outputting the light. In this case, the wavelength conversion member of the above described embodiments is replaced by a light guiding member and the light output from the light emitting device is output in the unchanged wavelength range from the angle conversion member.

The specific description of the shapes, the numbers, the placements, the materials, etc. of the respective component elements of the light source and the projector are not limited to those of the above described embodiments, but can be appropriately changed. Further, in the above described embodiments, the example in which the light source according to the present disclosure is provided in the projector using the liquid crystal panels is shown, however, the present disclosure is not limited to that. The light source according to the present disclosure may be applied to a projector using a digital micromirror device as the light modulation device. Furthermore, the projector does not necessarily have the plurality of light modulation devices, but may have only one light modulation device.

In the above described embodiments, the example in which the light source according to the present disclosure is applied to the projector is shown, however, the present disclosure is not limited to that. The light source according to the present disclosure may be applied to a lighting device, a headlight for automobile, or the like.

A light guiding unit according to an aspect of the present disclosure may have the following configurations.

A light guiding unit according to an aspect of the present disclosure includes a light guiding member outputting a light, an angle conversion member converting an angle distribution of the light output from the light guiding member, and an adhesive provided between the light guiding member and the angle conversion member and having light transmissivity, the light guiding member has an output end surface crossing longitudinal directions of the light guiding member and outputting the light and a side surface crossing the output end surface, the angle conversion member has an incident end surface entered by the light output from the output end surface, in a sectional view orthogonal to the output end surface, a dimension of the incident end surface is larger than a dimension of the output end surface, a part of the adhesive is provided between the output end surface and the incident end surface and another part of the adhesive is provided to cover a part of the side surface, in the sectional view orthogonal to the output end surface, a dimension of the adhesive provided to cover the part of the side surface is equal to or larger than the dimension of the output end surface and equal to or smaller than the dimension of the incident end surface, and the dimension of the adhesive is gradually larger from the side surface toward the incident end surface.

In the light guiding unit according to the aspect of the present disclosure, the angle conversion member may be a compound parabolic concentrator.

In the light guiding unit according to the aspect of the present disclosure, an outer surface of the adhesive is a curved surface and, in the sectional view orthogonal to the output end surface, an angle formed by a tangential line of the outer surface passing through a contact point between the outer surface and the incident end surface and the incident end surface may be larger than an angle formed by a tangential line of the outer surface passing through a contact point between the outer surface and the side surface and the incident end surface.

In the light guiding unit according to the aspect of the present disclosure, a first lyophilic property adjustment portion having a lyophilic property different from a lyophilic property in a center part of the incident end surface may be provided in a peripheral part of the incident end surface in contact with the adhesive.

In the light guiding unit according to the aspect of the present disclosure, a second lyophilic property adjustment portion having a lyophilic property different from a lyophilic property of the side surface not in contact with the adhesive may be provided in a part of the side surface in contact with the adhesive.

In the light guiding unit according to the aspect of the present disclosure, a second lyophilic property adjustment portion having a lyophilic property different from a lyophilic property of the side surface in contact with the adhesive may be provided in a part of the side surface not in contact with the adhesive.

A manufacturing method for a light guiding unit according to an aspect of the present disclosure may have the following configuration.

A manufacturing method for a light guiding unit according to an aspect of the present disclosure is a manufacturing method for a light guiding unit including a light guiding member outputting a light, an angle conversion member converting an angle distribution of the light output from the light guiding member, and an adhesive provided between the light guiding member and the angle conversion member and having light transmissivity, the light guiding member having an output end surface crossing longitudinal directions of the light guiding member and outputting the light and a side surface crossing the output end surface, the angle conversion member having an incident end surface entered by the light output from the output end surface, in a sectional view orthogonal to the output end surface, a dimension of the incident end surface being larger than a dimension of the output end surface, a part of the adhesive provided between the output end surface and the incident end surface and another part of the adhesive provided to cover a part of the side surface, including a first step of performing processing of adjusting a lyophilic property to the adhesive at least on one of a part of the incident end surface in contact with the adhesive and a part of the side surface, and a second step of providing the adhesive between the output end surface and the incident end surface and in a portion covering a part of the side surface and bonding the light guiding member and the angle conversion member performed after the first step.

A light source according to an aspect of the present disclosure may have the following configurations.

A light source according to an aspect of the present disclosure includes the light guiding unit according to the aspect of the present disclosure and a light emitting device outputting a light to the light guiding unit.

In the light source according to the aspect of the present disclosure, the light emitting device may output a first light having a first wavelength range, and the light guiding member may be a wavelength conversion member containing phosphor, converting the first light output from the light emitting device into a second light having a second wavelength range different from the first wavelength range, and outputting the second light.

A projector according to an aspect of the present disclosure may have the following configuration.

A projector according to an aspect of the present disclosure includes the light source according to the aspect of the present disclosure, a light modulation device modulating a light containing the second light output from the light source according to image information, and a projection optical device projecting the light modulated by the light modulation device.

What is claimed is:

1. A light guiding unit comprising:
a light guiding member outputting a light;
an angle conversion member converting an angle distribution of the light output from the light guiding member; and
an adhesive provided between the light guiding member and the angle conversion member and having light transmissivity, wherein
the light guiding member has an output end surface crossing longitudinal directions of the light guiding member and outputting the light and a side surface crossing the output end surface,
the angle conversion member has an incident end surface entered by the light output from the output end surface, in a sectional view orthogonal to the output end surface, a dimension of the incident end surface is larger than a dimension of the output end surface,
a part of the adhesive is provided between the output end surface and the incident end surface and another part of the adhesive is provided to cover a part of the side surface,
in the sectional view orthogonal to the output end surface, a dimension of the adhesive provided to cover the part of the side surface is equal to or larger than the dimension of the output end surface and equal to or smaller than the dimension of the incident end surface, and
the dimension of the adhesive is gradually larger from the side surface toward the incident end surface.

2. The light guiding unit according to claim 1, wherein
the angle conversion member is a compound parabolic concentrator.

3. The light guiding unit according to claim 2, wherein
an outer surface of the adhesive is a curved surface, and
in the sectional view orthogonal to the output end surface, an angle formed by a tangential line of the outer surface passing through a contact point between the outer surface and the incident end surface and the incident end surface is larger than an angle formed by a tangential line of the outer surface passing through a contact point between the outer surface and the side surface and the incident end surface.

4. The light guiding unit according to claim 3, wherein a first lyophilic property adjustment portion having a lyophilic property different from a lyophilic property in a center part of the incident end surface is provided in a peripheral part of the incident end surface in contact with the adhesive.

5. The light guiding unit according to claim 3, wherein
a second lyophilic property adjustment portion having a lyophilic property different from a lyophilic property of the side surface not in contact with the adhesive is provided in a part of the side surface in contact with the adhesive.

6. The light guiding unit according to claim 3, wherein
a second lyophilic property adjustment portion having a lyophilic property different from a lyophilic property of the side surface in contact with the adhesive is provided in a part of the side surface not in contact with the adhesive.

7. A manufacturing method for a light guiding unit including
a light guiding member outputting a light,
an angle conversion member converting an angle distribution of the light output from the light guiding member, and
an adhesive provided between the light guiding member and the angle conversion member and having light transmissivity,
the light guiding member having an output end surface crossing longitudinal directions of the light guiding member and outputting the light and a side surface crossing the output end surface,
the angle conversion member having an incident end surface entered by the light output from the output end surface, in a sectional view orthogonal to the output end surface, a dimension of the incident end surface being larger than a dimension of the output end surface,
a part of the adhesive provided between the output end surface and the incident end surface and another part of the adhesive provided to cover a part of the side surface,
the method comprising:
a first step of performing processing of adjusting a lyophilic property to the adhesive at least on one of a part of the incident end surface in contact with the adhesive and a part of the side surface; and
a second step of providing the adhesive between the output end surface and the incident end surface and in a portion covering a part of the side surface and bonding the light guiding member and the angle conversion member performed after the first step.

8. A light source comprising:
the light guiding unit according to claim 1; and
a light emitting device outputting a light to the light guiding unit.

9. The light source according to claim 8, wherein
the light emitting device outputs a first light having a first wavelength range, and
the light guiding member is a wavelength conversion member containing phosphor, converting the first light output from the light emitting device into a second light having a second wavelength range different from the first wavelength range, and outputting the second light.

10. A projector comprising:
the light source according to claim 8;
a light modulation device modulating the light output from the light source according to image information; and
a projection optical device projecting the light modulated by the light modulation device.
